(19) United States
(12) Patent Application Publication
(10) Pub. No.: US 2010/0270372 A1
(43) Pub. Date: Oct. 28, 2010

(54) WORK-CONDITION MANAGEMENT SYSTEM FOR PREVENTING INDUSTRIAL ACCIDENTS

(76) Inventor: Sun Bae BAE, Daejeon Metropolitan City (KR)

Correspondence Address: KNOBBE MARTENS OLSON & BEAR LLP, 2040 MAIN STREET, FOURTEENTH FLOOR, IRVINE, CA, 92614, US

(21) Appl. No.: 12/576,135

(22) Filed: Oct. 8, 2009

(30) Foreign Application Priority Data
Apr. 23, 2009 (KR) 10-2009-0035460

(51) Int. Cl. G06F 17/00

(52) U.S. Cl. 235/380; 235/375

(57) ABSTRACT

A work-condition management system for preventing industrial accidents is disclosed. In one embodiment, the system includes an attendance input terminal and a drunkometer connected to an alcohol-measuring probe, to analyze and check physical conditions of workers and judge the suitability of the workers for work to allow the selected workers to work, thus considerably reducing industrial accidents and product defects occurring in the industrial sites. In one embodiment, the work-condition management system includes a measuring device to measure vital signs including blood-alcohol level, blood pressure and body temperature and simply check physical conditions of attending workers, to considerably reduce safety-concerned industrial accidents and product defects occurring in the industrial sites, and a workability-deciding member to compare data obtained from the measuring device with a preset range for normal vital sign and determine the suitability of workers for work based on the comparison results, thereby improving work efficiency and decreasing product defects.

### RELATED APPLICATION

This application claims priority to and the benefit of Korean Patent Application No. 10-2009-0035460 filed in the Korean Intellectual Property Office on Apr. 23, 2009, the entire contents of which are incorporated herein by reference.

### BACKGROUND OF THE INVENTION

1. Field of the Invention

The present invention relates to a work-condition management system for preventing industrial accidents comprising a workability-deciding member which is provided with a database or memory to store physical conditions, production efficiency and product defects of workers, manages information of workers and judges the suitability of them for work to allow the selected workers to work, thus considerably reducing accidents and product defects occurring in the industrial sites.

2. Field of the Invention

Attendance cards are limitedly used as identification cards to open or close a gate for the purpose of checking the time to attend or leave the workplace and maintaining security thereof.

### SUMMARY OF CERTAIN INVENTIVE ASPECTS

One aspect of the present invention is a work-condition management system for preventing industrial accidents, comprising a device to objectively check vital signs indicating physical conditions of attending workers using measuring devices and determine the suitability of the workers for work, to reduce industrial accidents due to safety concerns and product defects when workers work in abnormal conditions such as drinking, blood pressure and body temperature and considerably improve work efficiency.

Another aspect of the present invention is a work-condition management system for preventing industrial accidents, which stores career history such as physical conditions and product defect rate and output of those who work for a long time monthly, quarterly and annually in a database, analyzes the data and determines the suitability of the workers for work and bonus payment levels, based on the analyzed results, thus reducing product defect rate, improving production efficiency, enhancing workers' health and encouraging positive living habits.

Another aspect of the present invention is a work-condition management system for preventing industrial accidents, including: a card reader to read an attendance card of an attending worker and an input terminal to input information of the worker; a measuring device synchronized with the card reader to read the attendance card of the worker, to confirm vital signs including blood-alcohol level of the worker; and a workability-deciding member to compare the vital sign data of worker input through the measuring device, the card reader and input terminal with a preset range for normal vital sign stored therein, and determine whether the worker is fit for work, wherein the workability-deciding member includes: a database or memory to store the preset range for normal vital sign of the worker to determine at attendance, whether the worker is fit for work; and a means to compare data input from the measuring device with the preset range and determine whether the corresponding worker can work.

The workability-deciding member may include a means synchronized with personal computer or terminal of the worker to inform work-suitability results determined by comparison of data input from the measuring device with the preset range, and the measured vital signs of the worker, in the form of a text message, on the display of the personal computer or terminal.

The workability-deciding member may compare data input through a drunkometer, the card reader, a hemadynamometer, a thermometer and the input terminal with the preset range, and determine that the corresponding worker can work normally, when the data is within the preset range for normal vital sign.

The work-condition management system may further include an operating means to calculate a bonus payment level, based on the work history including the vital signs, and product defect and output of the worker cumulatively stored in the database or memory.

The workability-deciding member may include an input terminal or personal computer to input self-diagnosis results with respect to the normal workability of the worker, wherein the workability-deciding member defines a case where the corresponding worker inputs normal workability in the input terminal or personal computer and the input data is out of the preset range but is within an allowable range in the workplace as “self-diagnosed normal workability”, and sets the input data as a limit of the preset range which in turn adjusts the preset range for determining whether the vital sign of the corresponding worker is normal, when product defect and output of the corresponding worker after normal working based on the defined self-diagnosed normal workability are within a preset normal range thereof.

### BRIEF DESCRIPTION OF THE DRAWINGS

FIG. 1 is a schematic diagram illustrating a work-condition management system for preventing industrial accidents according to one embodiment of the present invention.

FIG. 2 is a block diagram illustrating the constitution of a workability-deciding member according to one embodiment of the present invention.

FIG. 3 is a flow chart illustrating a mechanism for deciding the suitability of workers for work according to one embodiment of the present invention.

### DETAILED DESCRIPTION OF CERTAIN INVENTIVE EMBODIMENTS

Attendance cards have no additional device to check actual health conditions of workers and determine whether the workers are fit for work. In some cases, workers whose conditions such as drinking, body temperature and physical conditions are abnormal, disadvantageously cause industrial accidents due to safety concerns during work, and increase product defects, considerable deteriorating work efficiency.

In addition, the attendance cards also have neither a measuring device to check fatigue or bad physical conditions of workers due to factors such as drinking, business trips, sleep deprivation, etc., nor an input device to allow workers to input actual conditions themselves, thus inevitably allowing all of the workers to work, regardless of physical conditions of workers and disadvantageously increasing product defects and costs.

Furthermore, the attendance cards also have no separate device to record relations between body conditions of workers and product output and defect rate in a database for a long time, manage work history of the respective workers, check the body conditions and health of the workers and determine whether they are fit for work, thus disadvantageously causing product defects due to workers' error and increasing product costs and production time.

Workplaces where industrial accidents associated with safety concerns occur, suggest to confirm whether workers attending the workplace were drunk or not and to prevent workers whose alcohol concentration is high to a level allowing having negative effects on normal work from participating in work, thereby preventing safety-concerned accidents, increasing quality of products and reducing product costs. In recent years, there is an increase in workplaces that make such a suggestion.

Hereinafter, embodiments of the present invention will be described in detail with reference to the accompanying drawings.

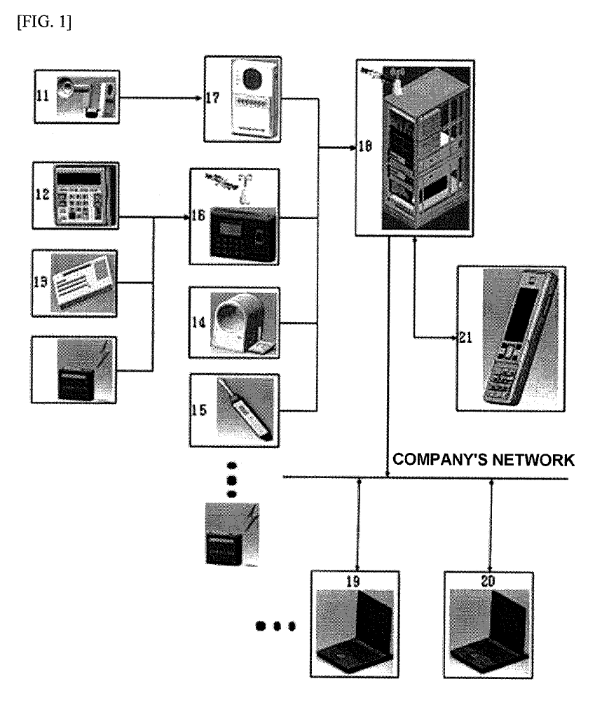

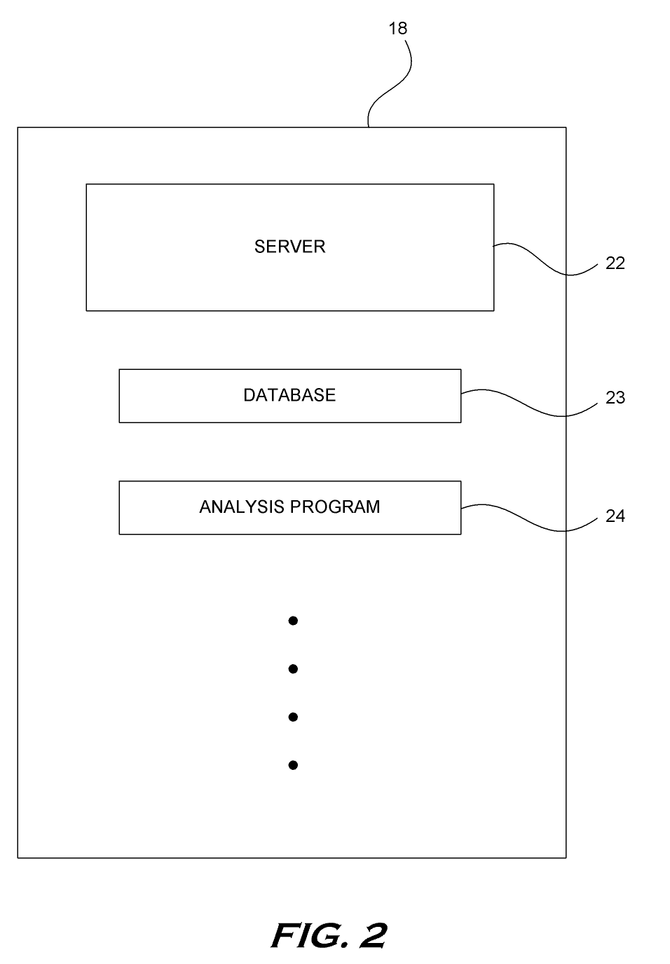

FIG. 1 is a schematic diagram illustrating a work-condition management system for preventing industrial accidents according to one embodiment of the present invention and FIG. 2 is a block diagram illustrating the constitution of a workability-deciding member to determine the suitability of workers for work.

The work-condition management system for preventing industrial accidents according to one embodiment of the present invention is capable of considerably reducing safety-associated industrial accidents occurring in the industry and product defects, analyzing correlation between workers' vital signs checked at attendance and product yield and defects to evaluate work attitude of the workers and thus calculate a bonus payment level, and reduce a lax attitude and thus increase production efficiency.

Workers who consume alcohol late at night and come to work the next morning, work in the project site or the workplace, thus disadvantageously causing safety concerns or considerable deterioration in work efficiency, increased product defects and increased raw material and labor costs. In some cases, workers who attended a funeral and thus lack sleep or are in abnormal physical conditions such as high body temperature attend and work at the office, thus disadvantageously increasing possibilities of industrial accidents or considerably deteriorating work efficiency.

In an attempt to solve the afore-mentioned problems, at least one embodiment of the prevent invention provides a work-condition management system for preventing industrial accidents, comprising a drunkometer 17 connected to an alcohol-measuring probe 11 or integrated with the alcohol-measuring probe 11, and an attendance input member 16 connected to a hemadynamometer 14 and a thermometer 15, and to a card reader 12 and an input terminal 13, to check the attendance of workers, measure vital signs thereof at this time and thus evaluate body conditions.

The work-condition management system may comprise only a part of the drunkometer, the hemadynamometer and the thermometer, depending on the workplace environment and intended purposes and may further comprise any measuring devices, so long as the devices can measure the body conditions of workers.

The work-condition management system comprises an attendance card and a card reader 12 to input confirmation, identification and attendance time of workers. That is, the attendance card and the card reader 12 allow for identification of workers, thus allowing data measured using respective measuring devices to match the corresponding values of workers. Preferably, the identification of workers using the attendance card and the card reader 12 is performed prior to measurement of vital signs using the measuring devices.

In addition, the work-condition management system also comprises a workability-deciding member 18 to determine whether respective workers can work normally, which compares vital signs between the measured values of workers and the normal range previously recorded in the database and/or memory and analyzes the same, to receive data associated with vital signs such as blood-alcohol level, blood pressure and body temperature from the measuring devices and thus determine whether respective workers can work normally.

As shown in FIG. 2, the workability-deciding member 18 comprises a memory in which an analysis program is provided, a database or memory 23 to store data input from various measuring devices and the attendance input member and attendance input terminal, an analysis program 24 to analyze work-suitability, diligence and bonus payment levels of workers, based on the stored data, and a server 22 to operate an operation program provided in a memory.

The analysis program 24 provided in the workability-deciding member 18 compares vital signs such as blood pressure, body temperature and blood-alcohol level of workers and the preset ranges thereof recorded in the database or memory 23 to analyze and judge whether the workers are in normal physical conditions and thus determine whether they can work normally. In addition, the analysis program 24 inputs and stores factors such as attendance time and physical conditions of workers, and product defects and yield with variation of physical conditions in the database or the memory 23.

More specifically, initially-set vital sign values are determined within the normal range, based on the general public. That is, the preset blood-alcohol level is calculated within a range, allowing for normal workability, based on the basic data, as set forth in the following Table 1 showing correlations between blood-alcohol level and physical conditions. For example, the preset blood-alcohol level is less than 0.05%, the lower limit of the blood-alcohol level at which response to stimulus is slightly retarded.

TABLE 1

| Blood-alcohol | |
|---|---|
| level | Mental and physical conditions |
| 0.02~0.03% | No remarkable variation, |
| | Slightly good feeling, |
| | Reddish skin |
| 0.05~0.06% | Relaxation and comfortableness |
| | Slow response to stimulus |
| | Slow muscular movement |
| 0.08% | Inferior adaptability to darkness |
| | Deteriorated discernment and attention |
| 0.10% | Deteriorated mental activity and judgment |
| | Loudly crying and nervousness |
| | Physical unbalance |
| 0.20% | Lost movement control and thus necessity of others' aid |
| | Tipsy lurch, quick heartbeat, nausea or vomiting |
| | Disorder in mental activity and repeated statement |
| 0.30% | Barely keep balance of the body under substantial |
| | unconsciousness |

In addition, the preset normal body temperature is determined within the range of 36.4 to 37.2° C., known as a normal human body temperature.

Also, the preset normal blood pressure is determined within the range of 110/70 mmHg to 120/80 mmHg (wherein 110 and 120 mean systolic blood pressures, and 70 and 80 mean diastolic blood pressures).

The preset ranges of blood-alcohol level, body temperature and blood pressure are pre-stored in the database and memory. The vital signs of blood-alcohol level, body temperature and blood pressure are based on the general public and cannot be applied to all workers. Accordingly, in accordance with one embodiment of the present invention, workers self-diagnose whether they are suitable for work, work normally according to the self-diagnosis results, and calculate product defects and output of workers to control the preset ranges for vital signs thereof.

That is, workers self-diagnose whether they are fit for work and input the diagnosis result in the input terminal or workers' personal computer. Accordingly, workers judge themselves whether they are fatigued or considerably deteriorated physical conditions at the attendance in the next morning due to drinking, business trips, sleep deprivation and other factors, and thus input the results therein. In addition, the preset ranges previously stored in the database or memory are determined based on the general public and respective workers self-diagnose whether they can work normally independent of the standard range, and thus, estimate their inherent normal ranges for vital signs. At this time, the case where a worker judges himself that he can work normally, although a vital sign value measured on the worker is out of the preset range, is defined as a self-diagnosed normal workability.

In the case of the self-diagnosed normal workability, the analysis program 24 determines whether workers can work normally, based on the gap in vital signs between the measured value of workers and the preset range. In the case where the measured value is far out of the preset range, an acceptable range may be determined, taking into consideration environments of workplaces such as the danger degree of workplaces, the level of difficulty of work and complexity of work. For example, the acceptable range may be unallowable for extremely dangerous workplaces, and may be allowable within about 10 to 20% beyond the preset range for workplaces slightly dangerous to safety-concerned accidents or simple tasks.

In addition, the acceptable range may be varied, depending on the types of vital signs measured. For example, the acceptable range is unallowable for the blood-alcohol level and is allowable within 10% beyond the preset range only for the blood pressure.

Also, workers who have the self-diagnosed normal workability and are under the acceptable range are committed in the workplace. As a result of working, in the case where product defects and output are in a preset range considered as normal, the analysis program 24 controls the preset range such that the vital sign data of the corresponding workers who judges themselves fit for work is adjusted to a limit of the preset range. As used herein, the preset range in which product defects and output are considered as normal may be determined within the average month (or year) product defects and output (including standard deviation), based on month (or year) average product defects and output of the corresponding workers and the product defects and output of other workers having the same career, age and gender.

In addition, the analysis program 24 is constituted such that it determines the bonus payment level, based on data input from apparatuses for measuring blood alcohol level, blood pressure and body temperature of workers and various data such as defects and output of products input and stored by workers and managers.

Meanwhile, the workability-deciding member is synchronized with wired/wireless terminals of workers' personal computers, and comprises a device to analyze physical conditions of attending workers and display the workability of the workers and/or the analysis results on personal computers 19 and 20 and/or through the display of a mobile communication terminal 21 such as cellular phones or PDAs, thus allowing workers to concentrate more on their work with reference to the displayed results.

Next, a mechanism for deciding the suitability of workers for working using the analysis program according to one embodiment of the present invention will be described.

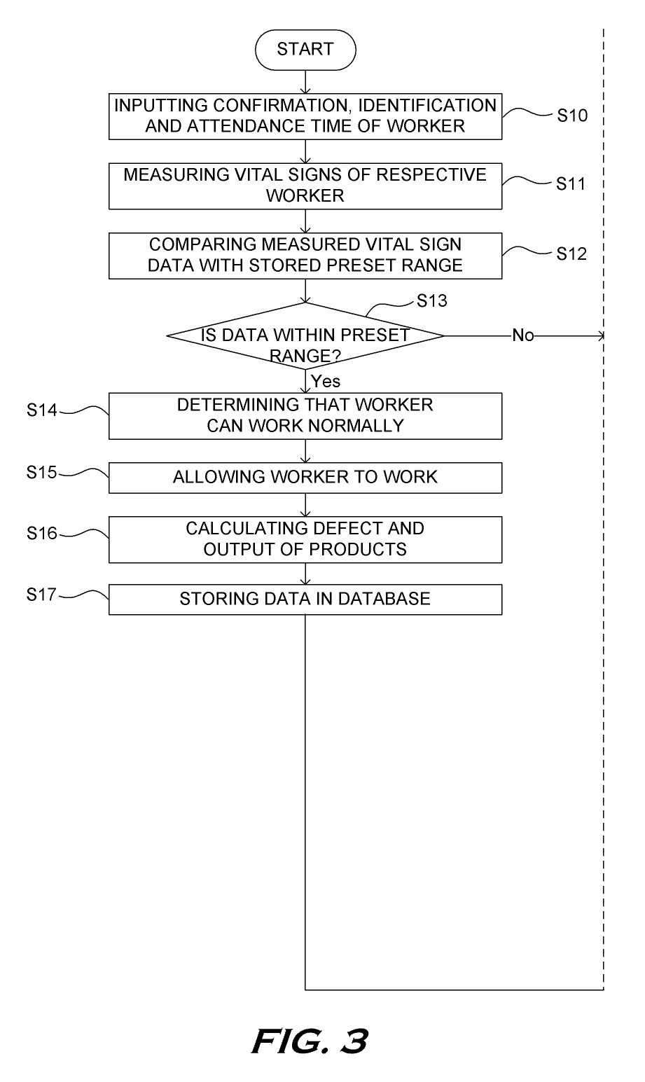

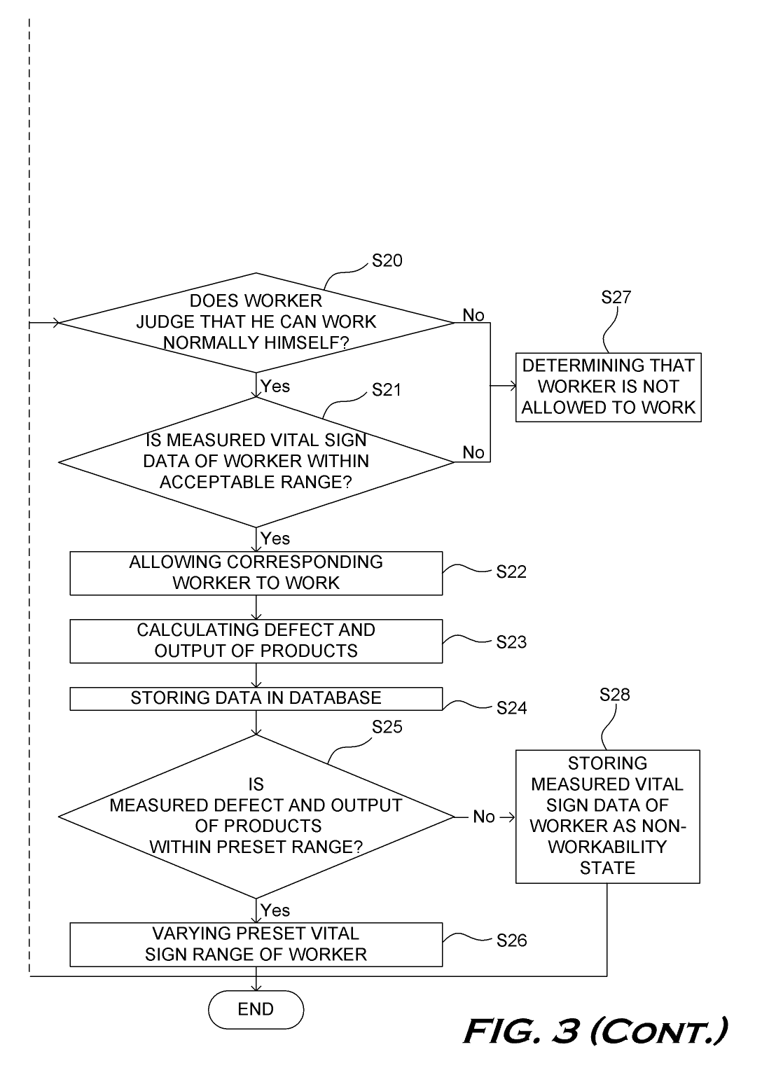

FIG. 3 is a flow chart illustrating a mechanism for deciding the suitability of workers for work according to one embodiment of the present invention.

First, respective workers input confirmation, identification and attendance time of workers in an input terminal or their personal computers (Step S10).

For respective workers, vital signs including blood-alcohol level, blood pressure and body temperature are measured with a drunkometer, a hemadynamometer and a thermometer, respectively (Step S11). The data of vital signs thus obtained are compared with the stored preset ranges (Step S12). The case where the measured data is within the preset range (in Step S13, “Yes”) means that vital signs of workers are within a normal range, thus allowing the workability-deciding member to determine that the workers can work normally (Step S14) and thus participate in working (Step S15).

After the corresponding workers finish working, defect and output of products handled by them on this day are calculated (Step S16) and the calculated results are stored in the database (Step S17). At this time, defect and output of products stored in the database serve as indices to analyze and decide the following bonus payment level.

Meanwhile, when the data is out of the preset range (Step S13, “No”), the corresponding worker self-diagnoses whether he can work normally (Step S20). At this time, when the worker self-diagnoses that he can work normally (Step S20, “Yes”), the workability-deciding member confirms whether the measured vital sign data of the corresponding worker are within the acceptable range (Step S21). When the measured vital sign data is within the acceptable range (Step S21, “Yes”), the corresponding worker is allowed to work (Step S22). On this day, the defect and output of products handled by the corresponding worker are calculated (Step S23) and stored in the database (Step S24).

The workability-deciding member judges whether the defect and output of products thus obtained are within the preset average range of the corresponding worker's ordinary product defect and output, or within the preset average range of the product defect and output of other workers having the same career, age and gender (Step S25).

When the product defect and output of the corresponding worker are within the preset range (Step S25, “Yes”), the workability-deciding member judges that the case where the measured vital sign data of the corresponding worker is out of the acceptable range is caused by characteristics of the corresponding worker and varies the corresponding measured data to a limit of the preset range. For example, when the preset body temperature is 36.4 to 37.2° C. and the measured data is 36.3° C., the preset body temperature is adjusted to 36.337.2° C. for the corresponding worker and stored in the database (Step S26).

On the other hand, when the defect and output of products thus obtained are out of the preset range (Step S25, “No”), the measured vital sign data of the corresponding worker are determined and stored as a non-workability state (Step S28). Accordingly, the corresponding worker is not allowed to work, although his measured vital sign data are out of the preset range and are within the acceptable range, and he self-diagnoses that he can work normally.

Meanwhile, either where he self-diagnoses that he cannot work normally (Step S20, “No”), or where his vital sign data are out of the acceptable range (Step S21, “No”), the workability-deciding member determines that the corresponding worker is not allowed to work (Step S27).

As apparent from the afore-going, at least one embodiment of the present invention provides a work-condition management system for preventing industrial accidents comprising a workability-deciding member whose database stores physical conditions of workers associated with product output and defect rate, manages career history of the workers and determines the suitability of workers for work, based on the history to allow only the selected workers to participate in working, thus advantageously considerably decreasing industrial accidents due to safety concerns occurring in the industrial site and product defects and improving production efficiency. Thus, at least one embodiment of the present invention is highly industrially applicable.

In accordance with one embodiment of the present invention, the work-condition management system for preventing industrial accidents comprises a device to objectively check vital signs indicating physical conditions of attending workers using measuring devices and determines whether the workers are suitable for work, to reduce industrial accidents due to safety concerns and product defects occurring when workers work in abnormal conditions such as drinking, blood pressure and body temperature and considerably improve work efficiency.

In accordance with one embodiment of the present invention, the work-condition management system for preventing industrial accidents which stores career history such as physical conditions and product defect rate and output of those who work for a long time monthly, quarterly and annually in a database, and analyzes the data to determine whether the workers are suitable for work and bonus payment levels, based on the analyzed results, thus advantageously reducing product defect rate, improving production efficiency, enhancing workers' health and encouraging positive living habits.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A work-condition management system for preventing industrial accidents, comprising:
a card reader configured to read an attendance card of an attending worker;
an input terminal configured to input information of the worker;
a measuring device synchronized with the card reader and configured to read the attendance card of the worker, to confirm vital signs including blood-alcohol level of the worker; and
a workability-deciding member configured to compare the vital sign data of worker input through the measuring device, the card reader and input terminal with a preset range for normal vital sign, and determine whether the worker is fit for work,
wherein the workability-deciding member comprises:
a database or memory configured to store the preset range for normal vital sign of the worker to determine at attendance whether the worker is fit for work; and
a comparing unit configured to compare data input from the measuring device with the preset range for normal vital sign and determine whether the corresponding worker can work.

2. The work-condition management system according to claim 1, further comprising an operating unit configured to calculate a bonus payment level, based on the work history including the vital signs, and product defect and output of the worker cumulatively stored in the database or memory.

3. The work-condition management system according to claim 1, wherein the workability-deciding member comprises an input terminal or personal computer to input self-diagnosis results with respect to the normal workability of the worker, and wherein the workability-deciding member is configured to define a case where the corresponding worker inputs normal workability in the input terminal or personal computer and the input data is out of the preset range but is within an allowable range in the workplace as self-diagnosed normal workability, and set the input data as a limit of the preset range which in turn adjusts the preset range for determining whether the vital sign of the corresponding worker is normal, when product defect and output of the corresponding worker after normal working based on the self-diagnosed normal workability are within a preset normal range thereof.

4. The work-condition management system according to claim 1, wherein the workability-deciding member comprises a unit synchronized with a personal computer or terminal of the worker and configured to inform work-suitability results determined by comparison of data input from the measuring device with the preset range for normal vital sign, and the measured vital signs of the worker, in the form of a text message, on the display of the personal computer or terminal.

5. The work-condition management system according to claim 4, further comprising an operating unit configured to calculate a bonus payment level, based on the work history including the vital signs, and product defect and output of the worker cumulatively stored in the database or memory.

6. The work-condition management system according to claim 4, wherein the workability-deciding member comprises an input terminal or personal computer to input self-diagnosis results with respect to the normal workability of the worker, and wherein the workability-deciding member is configured to define a case where the corresponding worker inputs normal workability in the input terminal or personal computer and the input data is out of the preset range but is within an allowable range in the workplace as self-diagnosed normal workability, and set the input data as a limit of the preset range which in turn adjusts the preset range for determining whether the vital sign of the corresponding worker is normal, when product defect and output of the corresponding worker after normal working based on the self-diagnosed normal workability are within a preset normal range thereof.

7. The work-condition management system according to claim 1, wherein the workability-deciding member is further configured to compare data input through a drunkometer, the card reader, a hemadynamometer, a thermometer and the input terminal with the preset range for normal vital sign, and determine that the corresponding worker can work normally, when the data is within the preset range for normal vital sign.

8. The work-condition management system according to claim 7, further comprising an operating unit configured to calculate a bonus payment level, based on the work history including the vital signs, and product defect and output of the worker cumulatively stored in the database or memory.

9. The work-condition management system according to claim 7, wherein the workability-deciding member comprises an input terminal or personal computer to input self-diagnosis results with respect to the normal workability of the worker, and wherein the workability-deciding member is configured to define a case where the corresponding worker inputs normal workability in the input terminal or personal computer and the input data is out of the preset range but is within an allowable range in the workplace as self-diagnosed normal workability, and set the input data as a limit of the preset range which in turn adjusts the preset range for determining whether the vital sign of the corresponding worker is normal, when product defect and output of the corresponding worker after normal working based on the self-diagnosed normal workability are within a preset normal range thereof.

10. A work-condition management system for preventing industrial accidents, comprising:
means for reading an attendance card of an attending worker;
means for inputting information of the worker;
measuring means, synchronized with the card reader, for reading the attendance card of the worker, to confirm vital signs including blood-alcohol level of the worker; and
means for comparing the vital sign data of worker input through the measuring device, the card reader and input terminal with a preset range for normal vital sign, and determine whether the worker is fit for work,
wherein the comparing means comprise:
a database or memory configured to store the preset range for normal vital sign of the worker to determine at attendance whether the worker is fit for work; and
a comparing unit configured to compare data input from the measuring device with the preset range for normal vital sign and determine whether the corresponding worker can work.
